(19) United States
(12) Patent Application Publication
(10) Pub. No.: US 2024/0276511 A1
(43) Pub. Date: Aug. 15, 2024

(54) INFORMATION PROCESSING METHOD, DEVICE AND EQUIPMENT

(71) Applicant: DATANG MOBILE COMMUNICATIONS EQUIPMENT CO., LTD., Beijing (CN)

(72) Inventors: Jinhua MIAO, Beijing (CN); Li CHEN, Beijing (CN)

(73) Assignee: DATANG MOBILE COMMUNICATIONS EQUIPMENT CO., LTD., Beijing (CN)

(21) Appl. No.: 18/646,720

(22) Filed: Apr. 25, 2024

Related U.S. Application Data
(63) Continuation of application No. 16/959,992, filed on Jul. 2, 2020.

(30) Foreign Application Priority Data
Jan. 9, 2018 (CN) 201810020219.6

(51) Int. Cl. H04W 72/23; H04L 1/1812; H04L 1/1822; H04L 5/00; H04W 72/0446; H04W 72/0453; H04W 72/50

(52) U.S. Cl. CPC H04W 72/23; H04L 1/1819; H04L 1/1822; H04L 5/0082; H04L 5/0092; H04L 5/0094; H04W 72/0446; H04W 72/535; H04L 5/0087; H04W 72/0453

(57) ABSTRACT

An information processing method, device and equipment are provided. The information processing method includes: transmitting configuration information to user equipment (UE), where the configuration information includes duration of a configured grant timer; the duration of the configured grant timer is configured independently for one or more of the following reference parameters: bandwidth part (BWP), transmission time interval (TTI) duration, uplink carrier, numerology or subcarrier space (SCS) corresponding to the numerology, or serving cell.

### CROSS-REFERENCE TO RELATED APPLICATIONS

The present application is a continuation application of U.S. patent application Ser. No. 16/959,992 filed on Jul. 2, 2020, which is a U.S. national phase application of a PCT Application No. PCT/CN2018/121471 filed on Dec. 17, 2018, which claims a priority to the Chinese patent application No. 201810020219.6, filed in China on Jan. 9, 2018, the disclosures of which are incorporated herein by reference in their entireties.

### TECHNICAL FIELD

The present disclosure relates to the field of communication technologies, and in particular, to an information processing method, device, and equipment.

### BACKGROUND

In the fifth generation mobile communication systems (5G or New Radio (NR) systems), the network bandwidth may be much larger than the terminal transmission bandwidth (the network bandwidth can be configured to a maximum of 400 MHz). However, the capabilities of user equipment (UEs) are different. For example, the capabilities of some UEs may not support such a large bandwidth, for example, for the purpose of power saving or the like.

The bandwidth part (BWP) configuration scenarios in the related art are as shown in FIG. 1a, FIG. 1b and FIG. 1c. In the scenario of FIG. 1a, the UE is limited in its ability to support data reception and transmission over a large bandwidth, so a smaller BWP needs to be configured. In the scenario of FIG. 1b, the UE supports the configuration of BWP2, but for power saving, the UE may choose to operate in BWP 1. In the scenario of FIG. 1c, the UE uses numerology 1 in BWP1 and numerology 2 in BWP2.

The numerology is a description of physical characteristics. The characteristics in numerology include: different subcarrier spaces (SCSs), different transmission time intervals (TTIs), etc. Different numerologies are provided with different parameters to meet different service requirements. For example, some services require shorter TTI duration, etc. In practical applications, the network side copes with various requirements by configuring different BWPs.

However, the UE can activate only a single BWP for one cell. Assuming that BWP1 and BWP2 both belong to a same cell, only one BWP can be activated for the UE at a time, i.e. the UE activates either BWP1 or BWP2. The UE may perform signaling and data transmission in an activated BWP and may switch between different BWPs. In the standardization discussion in the related art, it is agreed that retransmission can be performed between different BWPs, that is, the same hybrid automatic repeat request (HARQ) can be switched between different BWPs.

Configured grant scheduling refers to a transmission mode in which resources are allocated and scheduled in advance, and specifically includes: semi-persistent scheduling (SPS), and configured scheduling based on radio resource control (RRC) configuration.

In the discussion on NR, a scheme in which a downlink (DL) feedback channel is removed is employed. That is, after the uplink (UL) data is transmitted, there is no feedback channel similar to a physical hybrid ARQ indicator channel (PHICH) in Long Term Evolution (LTE), instead, a downlink control information (DCI) indication mode is used. If the UL data is transmitted incorrectly, the network side transmits retransmission DCI to request a retransmission, and if the UL data is transmitted correctly, the DCI is used to schedule the same HARQ process to perform a new transmission.

However, in the process of configured grant scheduling, the manner in which a new transmission is performed does not need to be indicated by the DCI. Instead, a new transmission is automatically triggered when certain time conditions are met. Therefore, this will result in that the UE is unable to ascertain when the HARQ process may be cleared off to perform a new transmission. As a result, a configured grant timer is defined.

However, there is no configuration and maintenance schemes for the configured grant timer in the related art, so that the accuracy of data transmission cannot be determined.

### SUMMARY

In a first aspect, the present disclosure provides, in some embodiments, an information processing method applied to a network side. The method includes: transmitting configuration information to user equipment (UE), where the configuration information includes duration of a configured grant timer; the duration of the configured grant timer is configured independently for one or more of following reference parameters: bandwidth part (BWP), transmission time interval (TTI) duration, uplink carrier, numerology or subcarrier space (SCS) corresponding to the numerology, or serving cell.

Optionally, when the reference parameter is BWP, a configured grant timer is independently configured for each BWP; or when the reference parameter is TTI duration, a configured grant timer is independently configured for each TTI; or when the reference parameter is uplink carrier, a configured grant timer is independently configured for each uplink carrier; or when the reference parameter is numerology or SCS corresponding to the numerology, a configured grant timer is independently configured for each numerology or SCS corresponding to the numerology; or when the reference parameter is serving cell, a configured grant timer is configured for each serving cell.

Optionally, the configuration information further includes timer running indication information, where the timer running indication information is used to indicate to the UE any one or more of following information: when the reference parameter is BWP, if a change of BWP occurs, running a configured grant timer corresponding to a BWP before the change or corresponding to a BWP after the change during the change of BWP to maintain a hybrid automatic repeat request (HARQ) process in the BWP before the change; when configured grant scheduling information is received or retransmission is initiated in the BWP after the change, running a configured grant timer corresponding to the BWP after the change; when the reference parameter is TTI duration, if a change of TTI occurs, running a configured grant timer corresponding to TTI duration before the change or corresponding to TTI duration after the change during the change of TTI to maintain an HARQ process in the TTI duration before the change; when the configured grant scheduling information is received or retransmission is initiated in the TTI duration after the change, running a configured grant timer corresponding to the TTI duration after the change; when the reference parameter is uplink carrier, if a change of uplink carrier occurs, running a configured grant timer corresponding to an uplink carrier before the change or corresponding to an uplink carrier after the change during the change of uplink carrier to maintain an HARQ process on the uplink carrier before the change; when the configured grant scheduling information is received or retransmission is initiated on the uplink carrier after the change, running a configured grant timer corresponding to the uplink carrier after the change.

Optionally, the starting position of the configured grant timer is the starting position of the subframe where the data transmission moment is located, or the starting position of the configured grant timer is the current slot of data transmission.

Optionally, a unit of the duration of the configured grant timer includes: subframe, symbol, or slot.

In a second aspect, the present disclosure provides, in some embodiments, an information processing method applied to UE. The method includes: receiving configuration information transmitted by a network side, where the configuration information includes duration of a configured grant timer; performing data transmission according to the configuration information and maintaining a state of the configured grant timer; where the duration of the configured grant timer is configured independently for one or more of the following reference parameters: BWP, TTI duration, uplink carrier, numerology or SCS corresponding to the numerology, or serving cell.

Optionally, the configuration information further includes timer running indication information, where the timer running indication information is used to indicate any one or more of the following information: when the reference parameter includes BWP, if a change of BWP occurs, running a configured grant timer corresponding to a BWP before the change or corresponding to a BWP after the change during the change of BWP to maintain an HARQ process in the BWP before the change; and when configured grant scheduling information is received or retransmission is initiated in the BWP after the change, running a configured grant timer corresponding to the BWP after the change; when the reference parameter includes TTI duration, if a change of TTI occurs, running a configured grant timer corresponding to TTI duration before the change or corresponding to TTI duration after the change during the change of TTI to maintain an HARQ process in the TTI duration before the change; when the configured grant scheduling information is received or retransmission is initiated in the TTI duration after the change, running a configured grant timer corresponding to the TTI duration after the change; when the reference parameter includes uplink carrier, if a change of uplink carrier occurs, running a configured grant timer corresponding to an uplink carrier before the change or corresponding to an uplink carrier after the change during the change of uplink carrier to maintain an HARQ process on the uplink carrier before the change; when the configured grant scheduling information is received or retransmission is initiated on the uplink carrier after the change, running a configured grant timer corresponding to the uplink carrier after the change.

Optionally, the performing data transmission according to the configuration information and maintaining the state of the configured grant timer includes: acquiring timer duration of a target configured grant timer according to current transmission characteristics; where the transmission characteristics include BWP, TTI duration, uplink carrier, numerology or SCS corresponding to the numerology, serving cell; when there is data to be transmitted in the HARQ process, transmitting a data packet, and starting or restarting the target configured grant timer; when it is determined according to the duration of the target configured grant timer that the target configured grant timer expires, terminating the HARQ process and stopping the target configured grant timer.

Optionally, the starting position of the configured grant timer is the starting position of the subframe where the data transmission moment is located, or the starting position of the configured grant timer is the current slot of data transmission.

Optionally, a unit of the duration of the configured grant timer includes: subframe, symbol, or slot.

In a third aspect, the present disclosure provides, in some embodiments, an information processing device. The device includes: a transmitting module, configured to transmit configuration information to UE, where the configuration information includes duration of a configured grant timer; the duration of the configured grant timer is configured independently for one or more of the following reference parameters: BWP, TTI duration, uplink carrier, numerology or SCS corresponding to the numerology, or serving cell.

Optionally, the configuration information further includes timer running indication information, where the timer running indication information is used to indicate to the UE any one or more of following information: when the reference parameter is BWP, if a change of BWP occurs, running a configured grant timer corresponding to a BWP before the change or corresponding to a BWP after the change during the change of BWP to maintain a hybrid automatic repeat request HARQ process in the BWP before the change; when configured grant scheduling information is received or retransmission is initiated in the BWP after the change, running a configured grant timer corresponding to the BWP after the change; when the reference parameter is TTI duration, if a change of TTI occurs, running a configured grant timer corresponding to TTI duration before the change or corresponding to TTI duration after the change during the change of TTI to maintain an HARQ process in the TTI duration before the change; when the configured grant scheduling information is received or retransmission is initiated in the TTI duration after the change, running a configured grant timer corresponding to the TTI duration after the change; when the reference parameter is uplink carrier, if a change of uplink carrier occurs, running a configured grant timer corresponding to an uplink carrier before the change or corresponding to an uplink carrier after the change during the change of uplink carrier to maintain an HARQ process on the uplink carrier before the change; when the configured grant scheduling information is received or retransmission is initiated on the uplink carrier after the change, running a configured grant timer corresponding to the uplink carrier after the change.

In a fourth aspect, the present disclosure provides, in some embodiments, an information processing device. The device includes: a receiving module, configured to receive configuration information transmitted by a network side, where the configuration information includes duration of a configured grant timer; a processing module, configured to perform data transmission according to the configuration information and maintain the state of the configured grant timer; where the duration of the configured grant timer is configured independently for one or more of following reference parameters: BWP, TTI duration, uplink carrier, numerology or SCS corresponding to the numerology, or serving cell.

Optionally, the configuration information further includes: timer running indication information, where the timer running indication information is used to indicate any one or more of the following information: when the reference parameter is BWP, if a change of BWP occurs, running a configured grant timer corresponding to a BWP before the change or corresponding to a BWP after the change during the change of BWP to maintain a hybrid automatic repeat request HARQ process in the BWP before the change; when configured grant scheduling information is received or retransmission is initiated in the BWP after the change, running a configured grant timer corresponding to the BWP after the change; when the reference parameter is TTI duration, if a change of TTI occurs, running a configured grant timer corresponding to TTI duration before the change or corresponding to TTI duration after the change during the change of TTI to maintain an HARQ process in the TTI duration before the change; when the configured grant scheduling information is received or retransmission is initiated in the TTI duration after the change, running a configured grant timer corresponding to the TTI duration after the change; when the reference parameter is uplink carrier, if a change of uplink carrier occurs, running a configured grant timer corresponding to an uplink carrier before the change or corresponding to an uplink carrier after the change during the change of uplink carrier to maintain an HARQ process on the uplink carrier before the change; when the configured grant scheduling information is received or retransmission is initiated on the uplink carrier after the change, running a configured grant timer corresponding to the uplink carrier after the change.

In a fifth aspect, the present disclosure provides, in some embodiments, information processing equipment. The equipment includes: a transceiver, a storage, a processor, and a program stored in the storage and configured to be executed by the processor; where the processor is configured to read the program in the storage and perform the following process: transmitting configuration information to UE, where the configuration information includes duration of a configured grant timer; or the processor is configured to transmit configuration information to UE through the transceiver, where the configuration information includes duration of a configured grant timer; the duration of the configured grant timer is configured independently for one or more of the following reference parameters: BWP, TTI duration, uplink carrier, numerology or SCS corresponding to the numerology, or serving cell.

Optionally, the processor is further configured to read the program in the storage and perform the following process: when the reference parameter is BWP, independently configuring a configured grant timer for each BWP; or when the reference parameter is TTI duration, independently configuring a configured grant timer for each TTI; or when the reference parameter is uplink carrier, independently configuring a configured grant timer for each uplink carrier; or when the reference parameter is numerology or SCS corresponding to the numerology, independently configuring a configured grant timer for each numerology or SCS corresponding to the numerology; or when the reference parameter is serving cell, configuring a configured grant timer for each serving cell.

Optionally, the processor is further configured to read the program in the storage and perform the following process: the configuration information further includes timer running indication information, where the timer running indication information is used to indicate to the UE any one or more of following information: when the reference parameter is BWP, if a change of BWP occurs, running a configured grant timer corresponding to a BWP before the change or corresponding to a BWP after the change during the change of BWP to maintain a hybrid automatic repeat request HARQ process in the BWP before the change; when the configured grant scheduling information is received or retransmission is initiated in the BWP after the change, running a configured grant timer corresponding to the BWP after the change; when the reference parameter is TTI duration, if a change of TTI occurs, running a configured grant timer corresponding to TTI duration before the change or corresponding to TTI duration after the change during the change of TTI to maintain an HARQ process in the TTI duration before the change; when the configured grant scheduling information is received or retransmission is initiated in the TTI duration after the change, running a configured grant timer corresponding to the TTI duration after the change; when the reference parameter is uplink carrier, if a change of uplink carrier occurs, running a configured grant timer corresponding to an uplink carrier before the change or corresponding to an uplink carrier after the change during the change of uplink carrier to maintain an HARQ process on the uplink carrier before the change; when the configured grant scheduling information is received or retransmission is initiated on the uplink carrier after the change, running a configured grant timer corresponding to the uplink carrier after the change.

Optionally, the starting position of the configured grant timer is the starting position of the subframe where the data transmission moment is located, or the starting position of the configured grant timer is the current slot of data transmission.

Optionally, a unit of the duration of the configured grant timer includes: subframe, symbol, or slot.

In a sixth aspect, the present disclosure provides, in some embodiments, information processing equipment. The equipment includes: a transceiver, a storage, a processor, and a program stored in the storage and configured to be executed by the processor; the transceiver is configured to receive configuration information transmitted by a network side, where the configuration information includes duration of a configured grant timer; the processor is configured to read the program in the storage and perform the following process: performing data transmission according to the configuration information and maintaining a state of the configured grant timer; where the duration of the configured grant timer is configured independently for one or more of the following reference parameters: BWP, TTI duration, uplink carrier, numerology or SCS corresponding to the numerology, or serving cell.

Optionally, the configuration information further includes: timer running indication information, where the timer running indication information is used to indicate any one or more of the following information: when the reference parameter is BWP, if a change of BWP occurs, running a configured grant timer corresponding to a BWP before the change or corresponding to a BWP after the change during the change of BWP to maintain a hybrid automatic repeat request HARQ process in the BWP before the change; when configured grant scheduling information is received or retransmission is initiated in the BWP after the change, running a configured grant timer corresponding to the BWP after the change; when the reference parameter includes TTI duration, if a change of TTI occurs, running a configured grant timer corresponding to TTI duration before the change or corresponding to TTI duration after the change during the change of TTI to maintain an HARQ process in the TTI duration before the change; when the configured grant scheduling information is received or retransmission is initiated in the TTI duration after the change, running a configured grant timer corresponding to the TTI duration after the change; when the reference parameter includes uplink carrier, if a change of uplink carrier occurs, running a configured grant timer corresponding to an uplink carrier before the change or corresponding to an uplink carrier after the change during the change of uplink carrier to maintain an HARQ process on the uplink carrier before the change; when the configured grant scheduling information is received or retransmission is initiated on the uplink carrier after the change, running a configured grant timer corresponding to the uplink carrier after the change.

Optionally, the processor is further configured to read the program in the storage and perform the following process: acquiring timer duration of a target configured grant timer according to the current transmission characteristics; where the transmission characteristics include BWP, TTI duration, uplink carrier, numerology or SCS corresponding to the numerology, serving cell; when there is data to be transmitted in the HARQ process, transmitting a data packet, and starting or restarting the target configured grant timer; and when it is determined according to the duration of the target configured grant timer that the target configured grant timer expires, terminating the HARQ process and stopping the target configured grant timer.

Optionally, the starting position of the configured grant timer is the starting position of the subframe where the data transmission moment is located, or the starting position of the configured grant timer is the current slot of data transmission.

Optionally, a unit of the duration of the configured grant timer includes: subframe, symbol, or slot.

In a seventh aspect, the present disclosure provides, in some embodiments, a computer-readable storage medium storing therein a computer program, where the computer program is configured to be executed by a processor to implement the steps in the method according to the first aspect, or the computer program is configured to be executed by a processor to implement the steps in the method according to the second aspect.

### BRIEF DESCRIPTION OF THE DRAWINGS

FIG. 1a, FIG. 1b, and FIG. 1c are schematic diagrams of BWP configuration scenarios in the related art, respectively;

FIG. 2 is a flow chart of an information processing method according to an embodiment of the present disclosure;

FIG. 3 is a flow chart of an information processing method according to an embodiment of the present disclosure;

FIG. 4 is a flow chart of an information processing method according to an embodiment of the present disclosure;

FIG. 5 is a schematic diagram of duration of configured grant timers corresponding to different TTIs according to an embodiment of the present disclosure;

FIG. 6 is a flow chart of an information processing method according to an embodiment of the present disclosure;

FIG. 7 is a schematic diagram of duration of configured grant timers corresponding to different BWPs according to an embodiment of the present disclosure;

FIG. 8 is a schematic diagram of an information processing device according to an embodiment of the present disclosure;

FIG. 9 is a schematic diagram of an information processing device according to an embodiment of the present disclosure;

FIG. 10 is a schematic diagram of communication equipment according to an embodiment of the present disclosure;

FIG. 11 is a schematic diagram of communication equipment according to an embodiment of the present disclosure.

### DETAILED DESCRIPTION

Specific embodiments of the present disclosure will be described in further detail below with reference to the accompanying drawings and examples. The following examples are intended to illustrate the present disclosure, but are not intended to limit the scope of the present disclosure.

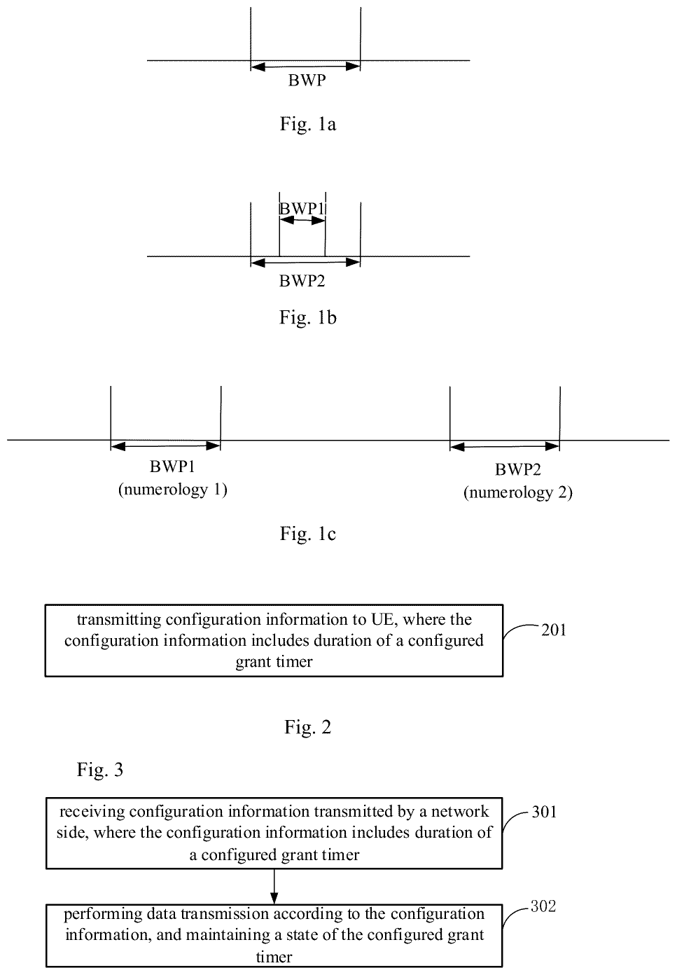

As shown in FIG. 2, the information processing method according to an embodiment of the present disclosure is applied to a network side, and includes: a step 201: transmitting configuration information to UE, where the configuration information includes duration of a configured grant timer.

The duration of the configured grant timer may be set by the network side according to different application environments or scenarios. The configured grant timer is used for recording whether a resource grant is valid. After the UE performs an initial transmission or retransmission, the configured grant timer is started. If the configured grant timer expires, the HARQ process of the resource grant is terminated and the corresponding transmission is delivered to a physical layer; when a scheduling command for the HARQ process is received (new transmission/retransmission), the configured grant timer is started or restarted.

The duration of the configured grant timer is configured independently for one or more of the following reference parameters: bandwidth part (BWP), transmission time interval (TTI) duration, uplink carrier, numerology or subcarrier space (SCS) corresponding to the numerology, or serving cell.

In the embodiment of the present disclosure, the configured grant timers may be configured independently for different reference parameters, respectively. Specifically, when the reference parameter is BWP, a configured grant timer is independently configured for each BWP; or when the reference parameter is TTI duration, a configured grant timer is independently configured for each TTI; or when the reference parameter is uplink carrier, a configured grant timer is independently configured for each uplink carrier; or when the reference parameter is numerology or SCS corresponding to the numerology, a configured grant timer is independently configured for each numerology or SCS corresponding to the numerology; or when the reference parameter is serving cell, a configured grant timer is configured for each serving cell.

The starting position of the configured grant timer is the starting position of a subframe where the data transmission moment is located, or the starting position of the configured grant timer is the current slot of data transmission. The unit of the duration of the configured grant timer includes: subframe, symbol, or slot.

For example, assuming that the reference parameter is BWP which include BWP1 and BWP2, configured grant timers may be configured for BWP1 and BWP2, respectively. It is assumed the configured grant timers have duration T1 and T2, respectively.

In addition, in order to further facilitate the determination of the accuracy of data transmission, the configuration information further includes: timer running indication information, where the timer running indication information is used to indicate to the UE any one or more of following information: when the reference parameter is BWP, if a change of BWP occurs, a configured grant timer corresponding to a BWP before the change or corresponding to a BWP after the change is run during the change of BWP to maintain a hybrid automatic repeat request HARQ process in the BWP before the change; when configured grant scheduling information is received or retransmission is initiated in the BWP after the change, a configured grant timer corresponding to the BWP after the change is run; when the reference parameter is TTI duration, if a change of TTI occurs, a configured grant timer corresponding to TTI duration before the change or corresponding to TTI duration after the change is run during the change of TTI to maintain an HARQ process in the TTI duration before the change; when the configured grant scheduling information is received or retransmission is initiated in the TTI duration after the change, a configured grant timer corresponding to the TTI duration after the change is run; when the reference parameter is uplink carrier, if a change of uplink carrier occurs, a configured grant timer corresponding to an uplink carrier before the change or corresponding to an uplink carrier after the change is run during the change of uplink carrier to maintain an HARQ process on the uplink carrier before the change; when the configured grant scheduling information is received or retransmission is initiated on the uplink carrier after the change, a configured grant timer corresponding to the uplink carrier after the change is run.

In the embodiment of the present disclosure, the network side transmits acquired duration of the configured grant timer to the UE, so that the UE side can perform data transmission according to the duration of the configured grant timer and the acquired configured grant scheduling information, and maintain the state of the grant timer, thereby determining the data transmission accuracy, and further arranging an effective retransmission or initiating a new transmission in time. Thus, the data transmission accuracy, the data transmission efficiency and the resource utilization rate are improved.

As shown in FIG. 3, an information processing method according to an embodiment of the present disclosure is applied to the UE, and includes following steps.

A step 301: receiving configuration information transmitted by a network side, where the configuration information includes duration of a configured grant timer.

The duration of the configured grant timer is configured independently for one or more of the following reference parameters: BWP, TTI duration, uplink carrier, numerology or SCS corresponding to the numerology, or serving cell.

The starting position of the configured grant timer is the starting position of the subframe where the data transmission moment is located, or the starting position of the configured grant timer is the current slot of data transmission. A unit of the duration of the configured grant timer includes: subframe, symbol, or slot.

A step 302: performing data transmission according to the configuration information, and maintaining a state of the configured grant timer.

Specifically, in this step, the UE acquires the timer duration of the target configured grant timer according to current transmission characteristics. The transmission characteristics include BWP, TTI duration, uplink carrier, numerology or SCS corresponding to the numerology, serving cell.

When there is data to be transmitted in the HARQ process, a data packet is transmitted, and the target configured grant timer is started or restarted; and when it is determined according to the duration of the target configured grant timer that the target configured grant timer expires, the HARQ process is terminated and the target configured grant timer is stopped.

In addition, in order to further facilitate the determination of the accuracy of data transmission, the configuration information further includes: timer running indication information, where the timer running indication information is used to indicate any one or more of the following information: when the reference parameter includes BWP, if a change of BWP occurs, running a configured grant timer corresponding to a BWP before the change or corresponding to a BWP after the change during the change of BWP to maintain a hybrid automatic repeat request HARQ process in the BWP before the change; when configured grant scheduling information is received or retransmission is initiated in the BWP after the change, running a configured grant timer corresponding to the BWP after the change; when the reference parameter includes TTI duration, if a change of TTI occurs, running a configured grant timer corresponding to TTI duration before the change or corresponding to TTI duration after the change during the change of TTI to maintain the HARQ process in the TTI duration before the change; when the configured grant scheduling information is received or retransmission is initiated in the TTI duration after the change, running a configured grant timer corresponding to the TTI duration after the change; when the reference parameter includes uplink carrier, if a change of uplink carrier occurs, running a configured grant timer corresponding to an uplink carrier before the change or corresponding to an uplink carrier after the change during the change of uplink carrier to maintain an HARQ process on the uplink carrier before the change; when the configured grant scheduling information is received or retransmission is initiated on the uplink carrier after the change, running a configured grant timer corresponding to the uplink carrier after the change.

For example, according to the timer running indication information, if a change of BWP, assuming that a BWP1 is changed to a BWP2, occurs during data transmission by the UE, a configured grant timer corresponding to the BWP1 before the change or corresponding to the BWP2 after the change is run during the change of BWP, to maintain an HARQ process in the BWP1 before the change; when configured grant scheduling information is received or a retransmission is initiated in the BWP2 after the change, a configured grant timer corresponding to the BWP2 after the change is run.

In the embodiment of the disclosure, the network side transmits the acquired duration of the configured grant timer to the UE, so that the UE side can perform data transmission according to the duration of the configured grant timer and the acquired configured grant scheduling information, and maintain the state of the grant timer, thereby determining the data transmission accuracy, and further arranging an effective retransmission or initiating a new transmission in time. Thus, the data transmission accuracy, the data transmission efficiency and the resource utilization rate are improved.

Hereinafter, an implementation process of the information processing method according to the embodiment of the present disclosure is described with reference to different reference parameters.

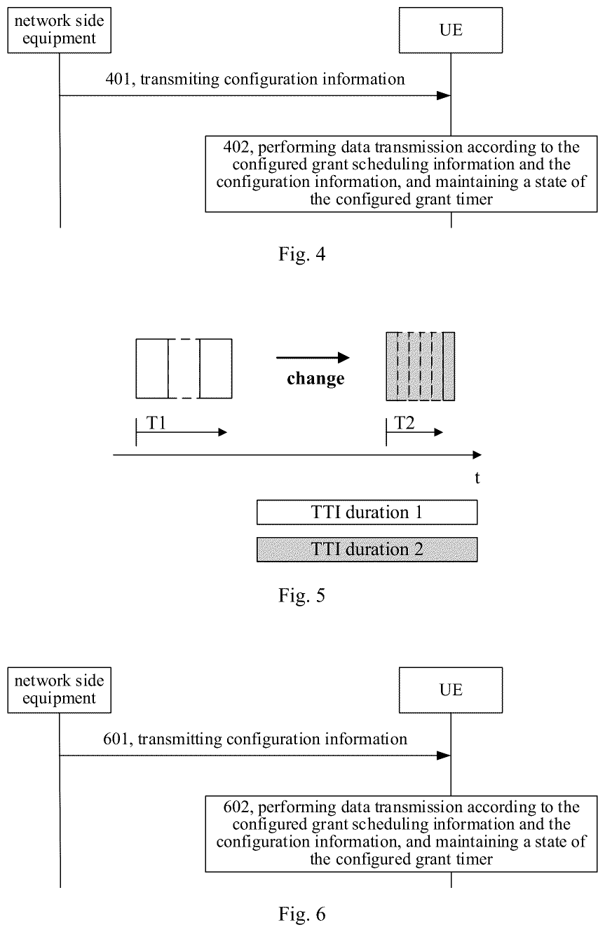

In this embodiment, a description is given by taking configuring different configured grant timers based on duration of TTIs as an example. As shown in FIG. 4, the information processing method according to the embodiment of the present disclosure includes the following process.

A step 401: a network side transmits configuration information to UE.

The configuration information includes: configured grant scheduling information, duration of a configured grant timer and corresponding TTI duration.

In the embodiment of the present disclosure, the duration of the configured grant timer is set to corresponding values based on different TTI duration.

In addition, the configuration information may further include timer running indication information, where the timer running indication information is used to indicate to the UE: if a change of TTI occurs, a configured grant timer corresponding to TTI duration before the change or corresponding to TTI duration after the change is run during the change of TTI to maintain the HARQ process in the TTI duration before the change; when the configured grant scheduling information is received or retransmission is initiated in the TTI duration after the change, a configured grant timer corresponding to the TTI duration after the change is run.

As shown in FIG. 5, in the case of different TTI duration, the duration of the configured grant timer is set to T1 for the duration of TTI 1; and the duration of the configured grant timer is set to T2 for the duration of TTI 2. The starting position of the duration of the configured grant timer may be the starting position of the subframe where the data transmission moment is located, or may be the current slot of data transmission. The unit of the duration of the configured grant timer may be subframe, symbol, or slot.

A step 402: UE performs data transmission according to the configured grant scheduling information and the configuration information, and maintains a state of the configured grant timer.

Specifically, when there is data to be transmitted in an HARQ process, the UE transmits a data packet, and starts or restarts the configured grant timer. When the timer expires, the data in the process is delivered to a physical layer. When a scheduling command (new transmission/retransmission) for this HARQ process is received, the UE starts or restarts the configured grant timer.

If the configuration information further includes timer running indication information, if a change of TTI occurs in the process of data transmission, a configured grant timer corresponding to TTI duration before the change or corresponding to TTI duration after the change is run during the change of TTI, to maintain the HARQ process in the TTI duration before the change; when the configured grant scheduling information is received or retransmission is initiated in the TTI duration after the change, a configured grant timer corresponding to the TTI duration after the change is run.

For example, if a change of TTI, assuming that a TTI 1 is changed to a TTI 2, occurs during data transmission, the UE runs a configured grant timer corresponding to TTI 1 before the change or corresponding to TTI 2 after the change during the change of TTI, to maintain the HARQ process in the TTI 1 before the change; and when configured grant scheduling information is received or retransmission is initiated in the TTI 2 after the change, the UE runs a configured grant timer corresponding to the TTI 2 after the change.

In this embodiment, a description is given by taking configuring different configured grant timers based on lengths of BWPs as an example. As shown in FIG. 6, the information processing method according to the embodiment of the present disclosure includes the following process.

A step 601: a network side transmits configuration information to UE.

The configuration information includes: configured grant scheduling information, the duration of the configured grant timer and corresponding length of BWP.

In the embodiment of the present disclosure, duration of the configured grant timer is set to corresponding values based on different lengths of BWPs.

In addition, the configuration information may further include timer running indication information, where the timer running indication information is used to indicate to the UE: if a change of BWP occurs, running a configured grant timer corresponding to a BWP before the change or corresponding to a BWP after the change during the change of BWP to maintain a hybrid automatic repeat request HARQ process in the BWP before the change; when the configured grant scheduling information is received or retransmission is initiated in the BWP after the change, running a configured grant timer corresponding to the BWP after the change.

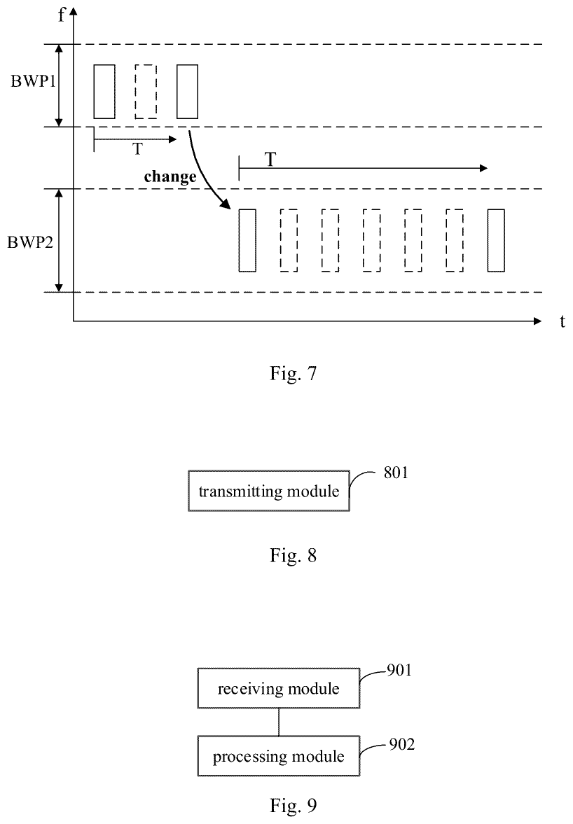

In the case of different BWPs, as shown in FIG. 7, the duration of the configured grant timer is set to T1 for the length of BWP1; the duration of the configured grant timer is set to T2 for the length of BWP2. The starting position of the configured grant timer may be a starting position of a subframe where the data transmission moment is located, or may be a current slot of data transmission. A unit of the duration of the configured grant timer may be on the order of a subframe, or may be a unit length of a current slot of data transmission.

A step 602: the UE performs data transmission according to the configured grant scheduling information and the configuration information, and maintains a state of the configured grant timer.

Specifically, when there is data to be transmitted in an HARQ process, the UE transmits a data packet, and starts or restarts the configured grant timer. When the timer expires, the data in the process is delivered to a physical layer. When a scheduling command (new transmission/retransmission) for this HARQ process is received, the UE starts or restarts the configured grant timer.

If the configuration information further includes timer running indication information, if a change of BWP occurs in the process of data transmission, a configured grant timer corresponding to a BWP before the change or corresponding to a BWP after the change is run during the change of BWP to maintain a hybrid automatic repeat request HARQ process in the BWP before the change; and when the configured grant scheduling information is received or retransmission is initiated in the BWP after the change, a configured grant timer corresponding to the BWP after the change is run.

For example, if a change of BWP, assuming that a BWP1 is changed to a BWP2, occurs during data transmission by the UE, the configured grant timer corresponding to the BWP1 before the change or corresponding to the BWP2 after the change is run during the change of BWP, to maintain the HARQ process in the BWP1 before the change; when the configured grant scheduling information is received or a retransmission is initiated in the BWP2 after the change, the configured grant timer corresponding to the BWP2 after the change is run.

As shown in FIG. 7, after a resource configuration process is changed to BWP2, if there is no corresponding configured grant scheduling information, the configured grant timer is stopped. Or, if corresponding numerology in BWP2 is different from numerology in BWP1, or other conditions cause the HARQ process to fail to retransmit in BWP2, the configured grant timer is stopped.

In an embodiment of the present disclosure, the duration of the configured grant timer may also be configured for different uplink carriers. The duration of the configured grant timer can be transmitted to the UE through the configuration information. For example, the duration of the supplementary uplink (SUL) configured grant timer corresponding to the uplink carrier 1 is T1, and the duration of the SUL configured grant timer corresponding to the uplink carrier 2 is T2. Also, in the embodiment of the present disclosure, the configuration information further includes timer running indication information, where the timer running indication information is used to indicate to the UE: if a change of uplink carrier occurs, running a configured grant timer corresponding to an uplink carrier before the change or corresponding to an uplink carrier after the change during the change of uplink carrier so as to maintain the HARQ process on the uplink carrier before the change; and when the configured grant scheduling information is received or retransmission is initiated on the uplink carrier after the change, running a configured grant timer corresponding to the uplink carrier after the change.

Then, if a change of uplink carrier occurs in the subsequent data transmission process by the UE, a configured grant timer corresponding to the uplink carrier before the change or corresponding to the uplink carrier after the change is run during the change of uplink carrier to maintain the HARQ process on the uplink carrier before the change; and when the configured grant scheduling information is received or retransmission is initiated on the uplink carrier after the change, the configured grant timer corresponding to the uplink carrier after the change is run.

For other processes of this embodiment, references may be made to descriptions of FIG. 4 or FIG. 6.

In an embodiment of the present disclosure, the duration of the configured grant timer may also be configured for different numerologies. For example, the duration of the SUL configured grant timer corresponding to numerology 1 is T3, and the duration of the SUL configured grant timer corresponding to numerology 2 is T4. For other processes of this embodiment, references may be made to descriptions of FIG. 4 or FIG. 6.

In an embodiment of the present disclosure, the duration of the configured grant timer may also be configured for SCSs of different numerologies. For example, the duration of the SUL configured grant timer corresponding to the SCS1 is T5, and the duration of the SUL configured grant timer corresponding to the SCS2 is T6. For other processes of this embodiment, references may be made to descriptions of FIG. 4 or FIG. 6.

In an embodiment of the present disclosure, the duration of the configured grant timer may also be configured for different serving cells. For example, the duration of the SUL configured grant timer corresponding to the serving cell 1 is T7, and the duration of the SUL configured grant timer corresponding to the serving cell 2 is T8. For other processes of this embodiment, references may be made to descriptions of FIG. 4 or FIG. 6.

In the above embodiments, the duration of the configured grant timer is configured according to different reference parameters, so that under different parameter characteristic configurations, improved determination and maintenance of data transmission accuracy, data transmission efficiency and resource utilization rate are achieved.

As shown in FIG. 8, an information processing device according to an embodiment of the present disclosure includes: a transmitting module 801, configured to transmit configuration information to UE, where the configuration information includes duration of a configured grant timer; the duration of the configured grant timer is configured independently for one or more of the following reference parameters: BWP, TTI duration, uplink carrier, numerology or SCS corresponding to the numerology, or serving cell.

The starting position of the configured grant timer is the starting position of the subframe where the data transmission moment is located, or the starting position of the configured grant timer is the current slot of data transmission. A unit of the duration of the configured grant timer includes: subframe, symbol, or slot.

Specifically, when the reference parameter is BWP, a configured grant timer is configured independently for each BWP; or when the reference parameter is TTI duration, a configured grant timer is configured independently for each TTI; or when the reference parameter is uplink carrier, a configured grant timer is configured independently for each uplink carrier; or when the reference parameter is numerology or SCS corresponding to the numerology, a configured grant timer is configured independently for each numerology or SCS corresponding to the numerology; or when the reference parameter is serving cell, a configured grant timer is configured for each serving cell.

In addition, in order to further facilitate the determination of the accuracy of data transmission, the configuration information further includes timer running indication information, where the timer running indication information is used to indicate to the UE any one or more of following information: when the reference parameter is BWP, if a change of BWP occurs, running a configured grant timer corresponding to the BWP before the change or corresponding to the BWP after the change during the change of BWP to maintain a hybrid automatic repeat request HARQ process in the BWP before the change; and when the configured grant scheduling information is received or retransmission is initiated in the BWP after the change, running a configured grant timer corresponding to the BWP after the change; when the reference parameter is TTI duration, if a change of TTI occurs, running a configured grant timer corresponding to TTI duration before the change or corresponding to TTI duration after the change during the change of TTI to maintain an HARQ process in the TTI duration before the change; when the configured grant scheduling information is received or retransmission is initiated in the TTI duration after the change, running a configured grant timer corresponding to the TTI duration after the change; when the reference parameter is uplink carrier, if a change of uplink carrier occurs, running a configured grant timer corresponding to an uplink carrier before the change or corresponding to an uplink carrier after the change during the change of uplink carrier to maintain an HARQ process on the uplink carrier before the change; when the configured grant scheduling information is received or retransmission is initiated on the uplink carrier after the change, running a configured grant timer corresponding to the uplink carrier after the change.

For the principle of operation of the device of the present disclosure, references may be made to the descriptions of the foregoing method embodiments.

In the embodiment of the disclosure, the network side transmits the acquired duration of the configured grant timer to the UE, so that the UE side can perform data transmission according to the duration of the configured grant timer and the acquired configured grant scheduling information, and maintain the state of the grant timer, thereby determining the data transmission accuracy, and further arranging an effective retransmission or initiating a new transmission in time. Thus, the data transmission accuracy, the data transmission efficiency and the resource utilization rate are improved.

As shown in FIG. 9, the information processing device according to the embodiment of the present disclosure includes: a receiving module 901, configured to receive configuration information transmitted by a network side, where the configuration information includes duration of a configured grant timer; a processing module 902, configured to perform data transmission according to the configuration information, and maintain the state of the configured grant timer; where the duration of the configured grant timer is configured independently for one or more of the following reference parameters: BWP, TTI duration, uplink carrier, numerology or SCS corresponding to the numerology, or serving cell.

The starting position of the configured grant timer is the starting position of the subframe where the data transmission moment is located, or the starting position of the configured grant timer is the current slot of data transmission. A unit of the duration of the configured grant timer includes: subframe, symbol, or slot.

The configuration information further includes: timer running indication information, where the timer running indication information is used to indicate any one or more of the following information: when the reference parameter includes BWP, if a change of BWP occurs, running a configured grant timer corresponding to a BWP before the change or corresponding to a BWP after the change during the change of BWP to maintain a hybrid automatic repeat request HARQ process in the BWP before the change; and when the configured grant scheduling information is received or retransmission is initiated in the BWP after the change, running a configured grant timer corresponding to the BWP after the change; when the reference parameter includes TTI duration, if a change of TTI occurs, running a configured grant timer corresponding to TTI duration before the change or corresponding to TTI duration after the change during the change of TTI to maintain the HARQ process in the TTI duration before the change; when the configured grant scheduling information is received or retransmission is initiated in the TTI duration after the change, running a configured grant timer corresponding to the TTI duration after the change; when the reference parameter includes uplink carrier, if a change of uplink carrier occurs, running a configured grant timer corresponding to an uplink carrier before the change or corresponding to an uplink carrier after the change during the change of uplink carrier to maintain an HARQ process on the uplink carrier before the change; when the configured grant scheduling information is received or retransmission is initiated on the uplink carrier after the change, running a configured grant timer corresponding to the uplink carrier after the change.

The processing module 902 is specifically configured for: acquiring the timer duration of a target configured grant timer according to current transmission characteristics, where the transmission characteristics include BWP, TTI duration, uplink carrier, numerology or SCS corresponding to the numerology, serving cell; when there is data to be transmitted in the HARQ process, transmitting a data packet, and starting or restarting the target configured grant timer; when it is determined according to the duration of the target configured grant timer that the target configured grant timer expires, terminating the HARQ process and stopping the target configured grant timer.

For the principle of operation of the device of the present disclosure, references may made to the descriptions of the foregoing method embodiments.

In the embodiment of the disclosure, the network side transmits the acquired duration of the configured grant timer to the UE, so that the UE side can perform data transmission according to the duration of the configured grant timer and the acquired configured grant scheduling information, and maintain the state of the grant timer, thereby determining the data transmission accuracy, and further arranging an effective retransmission or initiating a new transmission in time. Thus, the data transmission accuracy, the data transmission efficiency and the resource utilization rate are improved.

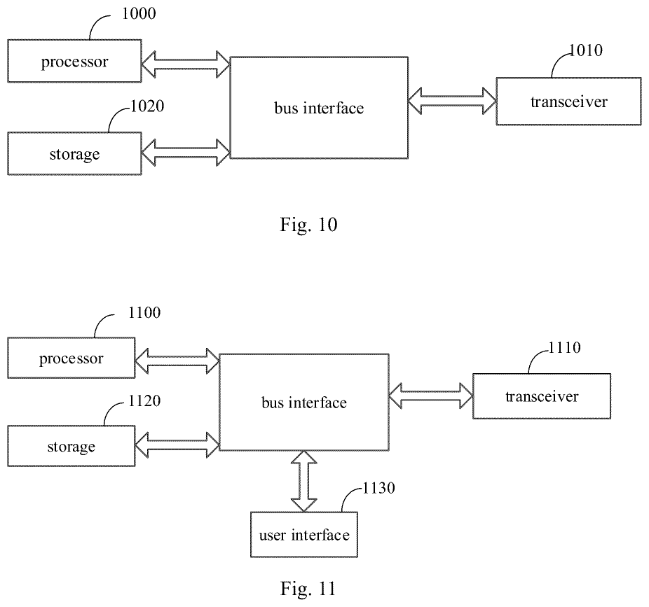

As shown in FIG. 10, information processing equipment according to an embodiment of the present disclosure includes:
a processor 1000, configured to read a program in a storage 1020 to implement the following process: transmitting configuration information to UE, where the configuration information includes the duration of a configured grant timer; or, a processor 1000, configured to read a program in a storage 1020, to implement the following process: transmitting configuration information to UE through a transceiver 1010, where the configuration information includes the duration of a configured grant timer;
the transceiver 1010, configured to receive and transmit data under the control of the processor 1000.

The duration of the configured grant timer is configured independently for one or more of the following reference parameters: BWP, TTI duration, uplink carrier, numerology or SCS corresponding to the numerology, or serving cell.

In FIG. 10, a bus architecture may include any number of interconnected buses and bridges. Various circuits, specifically, one or more processors represented by the processor 1000 and a storage represented by the storage 1020, are linked together. The bus architecture may also link various other circuits such as peripherals, voltage regulators and power management circuits, which are well known in the art, and therefore a further description is omitted herein. The bus interface provides interfaces. The transceiver 1010 may be a plurality of elements, that is, includes a transmitter and a receiver, to provide units configured to communicate with various other devices over a transmission medium. The processor 1000 is responsible for managing the bus architecture and general processing, and the storage 1020 may store data used by the processor 1000 when performing operations.

The processor 1000 is responsible for managing the bus architecture and general processing, and the storage 1020 may store data used by the processor 1000 when performing operations.

The processor 1000 is further configured to read the program to implement the following steps: when the reference parameter is BWP, independently configuring a configured grant timer for each BWP; or when the reference parameter is TTI duration, independently configuring a configured grant timer for each TTI; or when the reference parameter is uplink carrier, independently configuring a configured grant timer for each uplink carrier; or when the reference parameter is numerology or SCS corresponding to the numerology, independently configuring a configured grant timer for each numerology or SCS corresponding to the numerology; or when the reference parameter is serving cell, configuring a configured grant timer for each serving cell.

The processor 1000 is further configured to read the program to implement the following steps: the configuration information further includes timer running indication information, where the timer running indication information is used to indicate to the UE any one or more of following information: when the reference parameter is BWP, if a change of BWP occurs, running a configured grant timer corresponding to a BWP before the change or corresponding to a BWP after the change during the change of BWP to maintain a hybrid automatic repeat request HARQ process in the BWP before the change; and when the configured grant scheduling information is received or retransmission is initiated in the BWP after the change, running a configured grant timer corresponding to the BWP after the change; when the reference parameter is TTI duration, if a change of TTI occurs, running a configured grant timer corresponding to TTI duration before the change or corresponding to TTI duration after the change during the change of TTI to maintain the HARQ process in the TTI duration before the change; when the configured grant scheduling information is received or retransmission is initiated in the TTI duration after the change, running a configured grant timer corresponding to the TTI duration after the change; when the reference parameter is uplink carrier, if a change of uplink carrier occurs, running a configured grant timer corresponding to an uplink carrier before the change or corresponding to an uplink carrier after the change during the change of uplink carrier to maintain an HARQ process on the uplink carrier before the change; when the configured grant scheduling information is received or retransmission is initiated on the uplink carrier after the change, running a configured grant timer corresponding to the uplink carrier after the change.

The starting position of the configured grant timer is the starting position of the subframe where the data transmission moment is located, or the starting position of the configured grant timer is the current slot of data transmission.

A unit of the duration of the configured grant timer includes: subframe, symbol, or slot.

As shown in FIG. 11, information processing equipment according to an embodiment of the present disclosure includes: a processor 1100, configured to read the program in the storage 1120 to implement the following process: a transceiver 1110, configured to receive and transmit data under the control of a processor 1100, specifically, receive configuration information transmitted by a network side, where the configuration information includes duration of a configured grant timer; the processor 1100, configured to read the program in a storage 1120 to implement the following process: performing data transmission according to the configured grant scheduling information and the configuration information, and maintaining the state of the configured grant timer.

The duration of the configured grant timer is configured independently for one or more of the following reference parameters: BWP, TTI duration, uplink carrier, numerology or SCS corresponding to numerology, or serving cell.

In FIG. 11, a bus architecture may include any number of interconnected buses and bridges. Various circuits, specifically, one or more processors represented by the processor 1100 and a storage represented by the storage 1120, are linked together. The bus architecture may also link various other circuits such as peripherals, voltage regulators and power management circuits, which are well known in the art, and therefore a further description is omitted herein. The bus interface provides interfaces. The transceiver 1110 may be a plurality of elements, that is, includes a transmitter and a receiver, to provide units configured to communicate with various other devices over a transmission medium. For different UEs, user interface 1130 may be an interface configured to connect to a requisite device externally or internally, and the connected device includes, but is not limited to: a keypad, display, speaker, microphone, joystick, etc.

The processor 1100 is responsible for managing the bus architecture and general processing, and the storage 1120 may store data used by the processor 1100 when performing operations.

The configuration information further includes: timer running indication information, where the timer running indication information is used to indicate any one or more of the following information: when the reference parameter includes BWP, if a change of BWP occurs, running a configured grant timer corresponding to a BWP before the change or corresponding to a BWP after the change during the change of BWP to maintain a hybrid automatic repeat request HARQ process in the BWP before the change; when configured grant scheduling information is received or retransmission is initiated in the BWP after the change, running a configured grant timer corresponding to the BWP after the change; when the reference parameter includes TTI duration, if a change of TTI occurs, running a configured grant timer corresponding to TTI duration before the change or corresponding to TTI duration after the change during the change of TTI to maintain an HARQ process in the TTI duration before the change; when the configured grant scheduling information is received or retransmission is initiated in the TTI duration after the change, running a configured grant timer corresponding to the TTI duration after the change; when the reference parameter includes uplink carrier, if a change of uplink carrier occurs, running a configured grant timer corresponding to an uplink carrier before the change or corresponding to an uplink carrier after the change during the change of uplink carrier to maintain an HARQ process on the uplink carrier before the change; when the configured grant scheduling information is received or retransmission is initiated on the uplink carrier after the change, running a configured grant timer corresponding to the uplink carrier after the change.

The processor 1100 is further configured to read the program to implement the following steps: acquiring the timer duration of a target configured grant timer according to current transmission characteristics; where the transmission characteristics include BWP, TTI duration, uplink carrier, numerology or SCS corresponding to the numerology, serving cell; when there is data to be transmitted in the HARQ process, transmitting a data packet, and starting or restarting the target configured grant timer; when it is determined according to the duration of the target configured grant timer that the target configured grant timer expires, terminating the HARQ process and stopping the target configured grant timer.

The starting position of the configured grant timer is the starting position of the subframe where the data transmission moment is located, or the starting position of the configured grant timer is the current slot of data transmission.

A unit of the duration of the configured grant timer includes: subframe, symbol, or slot.

Furthermore, a computer-readable storage medium according to an embodiment of the present disclosure stores a computer program. The computer program is configured to be executed by a processor to implement the following steps: transmitting configuration information to UE, where the configuration information includes the duration of a configured grant timer; the duration of the configured grant timer is configured independently for one or more of the following reference parameters: BWP, TTI duration, uplink carrier, numerology or SCS corresponding to the numerology, or serving cell.

When the reference parameter is BWP, a configured grant timer is independently configured for each BWP; or when the reference parameter is TTI duration, a configured grant timer is independently configured for each TTI; or when the reference parameter is uplink carrier, a configured grant timer is independently configured for each uplink carrier; or when the reference parameter is numerology or SCS corresponding to the numerology, a configured grant timer is independently configured for each numerology or SCS corresponding to the numerology; or when the reference parameter is serving cell, a configured grant timer is configured for each serving cell.

The configuration information further includes timer running indication information, where the timer running indication information is used to indicate to the UE any one or more of the following information: when the reference parameter is BWP, if a change of BWP occurs, running a configured grant timer corresponding to a BWP before the change or corresponding to a BWP after the change during the change of BWP to maintain a hybrid automatic repeat request HARQ process in the BWP before the change; when configured grant scheduling information is received or retransmission is initiated in the BWP after the change, running a configured grant timer corresponding to the BWP after the change; when the reference parameter is TTI duration, if a change of TTI occurs, running a configured grant timer corresponding to TTI duration before the change or corresponding to TTI duration after the change during the change of TTI to maintain an HARQ process in the TTI duration before the change; when the configured grant scheduling information is received or retransmission is initiated in the TTI duration after the change, running a configured grant timer corresponding to the TTI duration after the change; when the reference parameter is uplink carrier, if a change of uplink carrier occurs, running a configured grant timer corresponding to an uplink carrier before the change or corresponding to an uplink carrier after the change during the change of uplink carrier to maintain an HARQ process on the uplink carrier before the change; when the configured grant scheduling information is received or retransmission is initiated on the uplink carrier after the change, running a configured grant timer corresponding to the uplink carrier after the change.

The starting position of the configured grant timer is the starting position of the subframe where the data transmission moment is located, or the starting position of the configured grant timer is the current slot of data transmission.

A unit of the duration of the configured grant timer includes: subframe, symbol, or slot.

Furthermore, a computer-readable storage medium according to an embodiment of the present disclosure stores a computer program. The computer program is configured to be executed by a processor to implement the following steps: receiving configuration information transmitted by a network side, where the configuration information includes the duration of a configured grant timer; performing data transmission according to the configured grant scheduling information and the configuration information, and maintaining the state of the configured grant timer; where the duration of the configured grant timer is configured independently for one or more of the following reference parameters: BWP, TTI duration, uplink carrier, numerology or SCS corresponding to the numerology, or serving cell.

The configuration information further includes timer running indication information, where the timer running indication information is used to indicate any one or more of the following information: when the reference parameter includes BWP, if a change of BWP occurs, running a configured grant timer corresponding to a BWP before the change or corresponding to a BWP after the change during the change of BWP to maintain a hybrid automatic repeat request HARQ process in the BWP before the change; when configured grant scheduling information is received or retransmission is initiated in the BWP after the change, running a configured grant timer corresponding to the BWP after the change; when the reference parameter includes TTI duration, if a change of TTI occurs, running a configured grant timer corresponding to TTI duration before the change or corresponding to TTI duration after the change during the change of TTI to maintain an HARQ process in the TTI duration before the change; when the configured grant scheduling information is received or retransmission is initiated in the TTI duration after the change, running a configured grant timer corresponding to the TTI duration after the change; when the reference parameter includes uplink carrier, if a change of uplink carrier occurs, running a configured grant timer corresponding to an uplink carrier before the change or corresponding to an uplink carrier after the change during the change of uplink carrier to maintain an HARQ process on the uplink carrier before the change; when the configured grant scheduling information is received or retransmission is initiated on the uplink carrier after the change, running a configured grant timer corresponding to the uplink carrier after the change.

The performing data transmission according to the configured grant scheduling information and the configuration information, and maintaining the state of the configured grant timer includes: acquiring the timer duration of a target configured grant timer according to current transmission characteristics; where, the transmission characteristics include BWP, TTI duration, uplink carrier, numerology or SCS corresponding to the numerology, serving cell; when there is data to be transmitted in the HARQ process, transmitting a data packet, and starting or restarting the target configured grant timer; when it is determined according to the duration of the target configured grant timer that the target configured grant timer expires, terminating the HARQ process and stopping the target configured grant timer.

The starting position of the configured grant timer is the starting position of the subframe where the data transmission moment is located, or the starting position of the configured grant timer is the current slot of data transmission.

A unit of the duration of the configured grant timer includes: subframe, symbol, or slot.

In some embodiments provided by the present application, it should be noted that, the disclosed methods and devices may be implemented in other manners. For example, the device embodiments described above are merely illustrative. For example, a division of units is only a logical function division. In actual implementation, there may be another division manner, for example, a plurality of units or components may be combined or may be integrated into another system, or some features may be ignored or not be executed. In addition, mutual coupling or direct coupling or communication connection shown or discussed may be an indirect coupling or communication connection through some interfaces, devices or units, and may be in an electrical, mechanical or other form.

In addition, each functional unit in various embodiments of the present disclosure may be integrated into one processing unit, or each unit may exist alone physically, or two or more units may be integrated into one unit. The integrated unit may be implemented in a form of hardware, or may also be implemented in a form of hardware plus a software functional unit.

The above integrated unit implemented in the form of a software functional unit may be stored in a computer readable storage medium. The above software functional unit is stored in a storage medium and includes several instructions so that a computer device (which may be a personal computer, a server, or a network device, etc.) to perform some steps of the methods described in various embodiments of the present disclosure. The foregoing storage medium includes various media capable of storing program codes, such as a USB flash drive, a mobile hard disk, a read-only memory (ROM), a random access memory (RAM), a magnetic disk, or an optical disc.

The descriptions above are optional embodiments of the present disclosure, it should be noted that improvements and the embellishments may be made by those of ordinary skill in the art within the scope of the principle of the disclosure, and these improvements and the embellishments shall be construed as falling within the scope of the present disclosure.

What is claimed is:

1. An information processing method, performed by a network side, comprising:
transmitting configuration information to user equipment (UE), wherein the configuration information comprises a duration of a configured grant timer, and the configured grant timer is used for recording whether a resource grant of a hybrid automatic repeat request (HARQ) process is valid;
wherein the duration of the configured grant timer is configured independently for one or more of following reference parameters: bandwidth part (BWP), uplink carrier, numerology or subcarrier space (SCS) corresponding to the numerology;
wherein the configured grant timer starts at a starting position of a subframe where UL data corresponding to the resource grant of the HARQ process is transmitted, or the configured grant timer starts at a slot where UL data corresponding to the resource grant of the HARQ process is transmitted.

2. The information processing method according to claim 1, wherein
when the reference parameter is BWP, a configured grant timer is configured independently for each BWP; or
when the reference parameter is uplink carrier, a configured grant timer is configured independently for each uplink carrier; or
when the reference parameter is numerology or SCS corresponding to the numerology, a configured grant timer is configured independently for each numerology or SCS corresponding to the numerology.

3. The information processing method according to claim 2, wherein the configuration information further comprises timer running indication information, the timer running indication information is used to indicate to the UE any one or more of following information:
when the reference parameter is BWP, if a change of BWP occurs, running a configured grant timer corresponding to a BWP before the change or corresponding to a BWP after the change during the change of BWP to maintain a hybrid automatic repeat request (HARQ) process in the BWP before the change; when configured grant scheduling information is received or retransmission is initiated in the BWP after the change, running a configured grant timer corresponding to the BWP after the change;
when the reference parameter is uplink carrier, if a change of uplink carrier occurs, running a configured grant timer corresponding to an uplink carrier before the change or corresponding to an uplink carrier after the change during the change of uplink carrier to maintain an HARQ process on the uplink carrier before the change; when the configured grant scheduling information is received or retransmission is initiated on the uplink carrier after the change, running a configured grant timer corresponding to the uplink carrier after the change.

4. The information processing method according to claim 1, wherein a unit of the duration of the configured grant timer comprises: subframe, symbol, or slot.

5. An information processing method, performed by user equipment (UE), comprising:
receiving configuration information transmitted by a network side, wherein the configuration information comprises a duration of a configured grant timer, and the configured grant timer is used for recording whether a resource grant of a hybrid automatic repeat request (HARQ) process is valid;
performing data transmission according to the configuration information and maintaining a state of the configured grant timer;
wherein the duration of the configured grant timer is configured independently for one or more of following reference parameters: bandwidth part (BWP), uplink carrier, numerology or subcarrier space (SCS) corresponding to the numerology;
wherein the configured grant timer starts at a starting position of a subframe where UL data corresponding to the resource grant of the HARQ process is transmitted, or the configured grant timer starts at a slot where UL data corresponding to the resource grant of the HARQ process is transmitted.

6. The information processing method according to claim 5, wherein the configuration information further comprises timer running indication information, the timer running indication information is used to indicate any one or more of following information:
when the reference parameter comprises BWP, if a change of BWP occurs, running a configured grant timer corresponding to a BWP before the change or corresponding to a BWP after the change during the change of BWP to maintain a hybrid automatic repeat request (HARQ) process in the BWP before the change; when configured grant scheduling information is received or retransmission is initiated in the BWP after the change, running a configured grant timer corresponding to the BWP after the change;
when the reference parameter comprises uplink carrier, if a change of uplink carrier occurs, running a configured grant timer corresponding to an uplink carrier before the change or corresponding to an uplink carrier after the change during the change of uplink carrier to maintain an HARQ process on the uplink carrier before the change; when the configured grant scheduling information is received or retransmission is initiated on the uplink carrier after the change, running a configured grant timer corresponding to the uplink carrier after the change.

7. The information processing method according to claim 5, wherein the performing data transmission according to the configuration information and maintaining the state of the configured grant timer comprises:
acquiring timer duration of a target configured grant timer according to current transmission characteristics; wherein, the transmission characteristics comprise BWP, uplink carrier, numerology or SCS corresponding to the numerology;
when there is data to be transmitted in the HARQ process, transmitting a data packet, and starting or restarting the target configured grant timer; when it is determined according to the duration of the target configured grant timer that the target configured grant timer expires, terminating the HARQ process and stopping the target configured grant timer.

8. The information processing method according to claim 5, wherein a unit of the duration of the configured grant timer comprises: subframe, symbol, or slot.

9. Information processing equipment, comprising: a transceiver, a storage, a processor, and a program stored in the storage and configured to be executed by the processor; wherein
the processor is configured to read the program in the storage to implement the steps in the method according to claim 1.

10. The information processing equipment according to claim 9, wherein the processor is further configured to read the program in the storage and perform following process:
when the reference parameter is BWP, independently configuring a configured grant timer for each BWP; or
when the reference parameter is uplink carrier, independently configuring a configured grant timer for each uplink carrier; or
when the reference parameter is numerology or SCS corresponding to the numerology, independently configuring a configured grant timer for each numerology or SCS corresponding to the numerology.

11. The information processing equipment according to claim 10, wherein the processor is further configured to read the program in the storage and perform following process:
the configuration information further comprises timer running indication information, wherein the timer running indication information is used to indicate to the UE any one or more of following information:
when the reference parameter is BWP, if a change of BWP occurs, running a configured grant timer corresponding to a BWP before the change or corresponding to a BWP after the change during the change of BWP to maintain a hybrid automatic repeat request (HARQ) process in the BWP before the change; when configured grant scheduling information is received or retransmission is initiated in the BWP after the change, running a configured grant timer corresponding to the BWP after the change;
when the reference parameter is uplink carrier, if a change of uplink carrier occurs, running a configured grant timer corresponding to an uplink carrier before the change or corresponding to an uplink carrier after the change during the change of uplink carrier to maintain an HARQ process on the uplink carrier before the change; when the configured grant scheduling information is received or retransmission is initiated on the uplink carrier after the change, running a configured grant timer corresponding to the uplink carrier after the change.

12. The information processing equipment according to claim 9, wherein a unit of the duration of the configured grant timer comprises: subframe, symbol, or slot.

13. Information processing equipment, comprising: a transceiver, a storage, a processor, and a program stored in the storage and configured to be executed by the processor; wherein
the processor is configured to read the program in the storage to implement following steps:
receiving configuration information transmitted by a network side, wherein the configuration information comprises a duration of a configured grant timer, and the configured grant timer is used for recording whether a resource grant of a hybrid automatic repeat request (HARQ) process is valid;
performing data transmission according to the configuration information and maintaining a state of the configured grant timer;
wherein the duration of the configured grant timer is configured independently for one or more of following reference parameters: bandwidth part (BWP), uplink carrier, numerology or subcarrier space (SCS) corresponding to the numerology;
wherein the configured grant timer starts at a starting position of a subframe where UL data corresponding to the resource grant of the HARQ process is transmitted, or the configured grant timer starts at a slot where UL data corresponding to the resource grant of the HARQ process is transmitted.

14. The information processing equipment according to claim 13, wherein the configuration information further comprises timer running indication information, the timer running indication information is used to indicate any one or more of following information:
when the reference parameter comprises BWP, if a change of BWP occurs, running a configured grant timer corresponding to a BWP before the change or corresponding to a BWP after the change during the change of BWP to maintain a hybrid automatic repeat request (HARQ) process in the BWP before the change; when configured grant scheduling information is received or retransmission is initiated in the BWP after the change, running a configured grant timer corresponding to the BWP after the change;
when the reference parameter comprises uplink carrier, if a change of uplink carrier occurs, running a configured grant timer corresponding to an uplink carrier before the change or corresponding to an uplink carrier after the change during the change of uplink carrier to maintain an HARQ process on the uplink carrier before the change; when the configured grant scheduling information is received or retransmission is initiated on the uplink carrier after the change, running a configured grant timer corresponding to the uplink carrier after the change.

15. The information processing equipment according to claim 13, wherein the processor is further configured to read the program in the storage and perform following process:
acquiring timer duration of a target configured grant timer according to current transmission characteristics; wherein the transmission characteristics comprise BWP, uplink carrier, numerology or SCS corresponding to the numerology;
when there is data to be transmitted in the HARQ process, transmitting a data packet, and starting or restarting the target configured grant timer;
when it is determined according to the duration of the target configured grant timer that the target configured grant timer expires, terminating the HARQ process and stopping the target configured grant timer.

16. The information processing equipment according to claim 13, wherein a unit of the duration of the configured grant timer comprises: subframe, symbol, or slot.

17. A non-transitory computer-readable storage medium storing therein a computer program, wherein the computer program is configured to be executed by a processor to implement the steps in the method according to claim 1.

18. A non-transitory computer-readable storage medium storing therein a computer program, wherein the computer program is configured to be executed by a processor to implement the steps in the method according to claim 5.
